(19) United States
(12) Patent Application Publication
(10) Pub. No.: US 2016/0239853 A1
(43) Pub. Date: Aug. 18, 2016

(54) METHOD AND SYSTEM FOR PROVIDING INSIGHTS TO MERCHANTS BASED ON CONSUMER TRANSACTION HISTORY

(71) Applicant: MasterCard International Incorporated, Purchase, NY (US)

(72) Inventors: Oran CUMMINS, Dublin 16 (IE); Kimberly Ann PURCELL, Wilton, CT (US); Kaitlin TRIANO, Greenwich, CT (US); Sruba DE, Houston, TX (US)

(73) Assignee: MasterCard International Incorporated, Purchase, NY (US)

(21) Appl. No.: 15/042,701

(22) Filed: Feb. 12, 2016

Related U.S. Application Data
(60) Provisional application No. 62/115,453, filed on Feb. 12, 2015.

(51) Int. Cl. G06Q 30/02

(52) U.S. Cl. CPC G06Q 30/0201

(57) ABSTRACT

A method for providing insight metrics for transaction behavior includes: storing account profiles, each including a profile identifier and transaction data entries including transaction data related to a payment transaction; receiving a first data file including a specific identifier associated with a specific merchant and an account identifier of a group of one or more account identifiers; identifying, for each account identifier of the group, a related account profile based on a correspondence between the profile identifier and the respective account identifier; identifying metric values for each identified account profile, wherein each metric values is associated with a desired metric and is based on the transaction data included in each transaction data entry included in the respective account profile; generating a second data file including at least the account identifier corresponding to each identified account profile; and transmitting the generated second data file.

### FIELD

The present disclosure relates to the providing of insight metrics to merchants and other entities based on transaction behavior, specifically the generation of insights based on a consumer's full transaction behavior for delivery to a merchant where the consumer may be a customer of the merchant and may have transaction behavior including transactions not involving the merchant.

### BACKGROUND

Merchants are often interested in learning as much as they can about their customers. Learning more about their customers can enable a merchant to provide better goods and services to customers, increase sales to the customers, encourage future transactions, and earn referral business. In an effort to learn more about their customers, many merchants will often retain a history of transactions involving each customer, and may also encourage their customers to participate in surveys and other information gathering techniques. However, such transaction history only involves transactions also involving the merchant, which may provide a very incomplete look at the customer's overall transaction behavior. In addition, surveys and other information gathering techniques are limited to what information is explicitly asked for, and what information the customer thinks to provide.

As such, there is a need for more effective insights regarding customers to provide to a merchant. It may be beneficial to develop insights for consumers that take into account the consumer's overall transaction history that involves more than just the transactions involving the merchant desiring the metrics. However, merchants are often unable to receive or access such information, as the merchant may not have any method for accessing such data, and may also be prevented in obtaining financial information directly associated with a consumer. Thus, there is a need for a technical solution where a merchant can be provided with consumer insights for a customer, which are based on transaction history involving more than just the merchant. Such insights may be beneficial to the merchant, and may also protect privacy of the consumers as it may protect the transaction information for the consumer from being obtained by the merchant, while still enabling the merchant the use of the resulting insights.

### SUMMARY

The present disclosure provides a description of systems and methods for providing insight metrics for transaction behavior.

A method for providing insight metrics for transaction behavior includes: storing, in an account database of a processing server, a plurality of account profiles, wherein each account profile includes a structured data set related to a transaction account including at least a plurality of transaction data entries, each transaction data entry including data related to a payment transaction involving the related transaction account including at least a transaction time and/or date, a transaction amount, a merchant identifier, and additional transaction data; receiving, by a receiving device of the processing server, a first data file, wherein the first data file includes at least a specific identifier associated with a specific merchant, one or more desired metrics, and a plurality of merchant transaction entries, each merchant transaction entry including data related to a payment transaction involving the specific merchant including at least a transaction time and/or date, a transaction amount, and an account identifier of a group of one or more account identifiers; executing, by a querying module of the processing server, a query on the account database to identify, for each account identifier of the group of one or more account identifiers, a related account profile based on a correspondence between the transaction time and/or date and transaction amount included in one or more of the merchant transaction entries included in the first data file that includes the respective account identifier and the transaction time and/or date and transaction amount included in one or more of the transaction data entries included in the respective account profile that includes a merchant identifier corresponding to the specific identifier; identifying, by an analytic module of the processing server, one or more metric values for each identified account profile, wherein each of the one or more metric values is associated with the one or more desired metrics included in the received first data file and is based on at least one of: the transaction time and/or date, transaction amount, and additional transaction data included in each transaction data entry included in the respective account profile; generating, by a generation module of the processing server, a second data file, wherein the second data file includes at least the account identifier corresponding to each of the identified account profiles; and electronically transmitting, by a transmitting device of the processing server, the generated second data file.

Another method for providing insight metrics for transaction behavior includes: storing, in an account database of a processing server, a plurality of account profiles, wherein each account profile includes a structured data set related to a transaction account including at least a profile identifier and a plurality of transaction data entries, each transaction data entry including data related to a payment transaction involving the related transaction account including at least a transaction time and/or date, a transaction amount, a merchant identifier, and additional transaction data; receiving, by a receiving device of the processing server, a first data file, wherein the first data file includes at least a specific identifier associated with a specific merchant and an account identifier of a group of one or more account identifiers; executing, by a querying module of the processing server, a query on the account database to identify, for each account identifier of the group of one or more account identifiers, a related account profile based on a correspondence between the included profile identifier and the respective account identifier; identifying, by an analytic module of the processing server, one or more metric values for each identified account profile, wherein each of the one or more metric values is associated with the one or more desired metrics included in the received first data file and is based on at least one of: the transaction time and/or date, transaction amount, and additional transaction data included in each transaction data entry included in the respective account profile; generating, by a generation module of the processing server, a second data file, wherein the second data file includes at least the account identifier corresponding to each of the identified account profiles; and electronically transmitting, by a transmitting device of the processing server, the generated second data file.

A system for providing insight metrics for transaction behavior includes: an account database of a processing server configured to store a plurality of account profiles, wherein each account profile includes a structured data set related to a transaction account including at least a plurality of transaction data entries, each transaction data entry including data related to a payment transaction involving the related transaction account including at least a transaction time and/or date, a transaction amount, a merchant identifier, and additional transaction data; a receiving device of the processing server configured to receive a first data file, wherein the first data file includes at least a specific identifier associated with a specific merchant, one or more desired metrics, and a plurality of merchant transaction entries, each merchant transaction entry including data related to a payment transaction involving the specific merchant including at least a transaction time and/or date, a transaction amount, and an account identifier of a group of one or more account identifiers; a querying module of the processing server configured to execute a query on the account database to identify, for each account identifier of the group of one or more account identifiers, a related account profile based on a correspondence between the transaction time and/or date and transaction amount included in one or more of the merchant transaction entries included in the first data file that includes the respective account identifier and the transaction time and/or date and transaction amount included in one or more of the transaction data entries included in the respective account profile that includes a merchant identifier corresponding to the specific identifier; an analytic module of the processing server configured to identify one or more metric values for each identified account profile, wherein each of the one or more metric values is associated with the one or more desired metrics included in the received first data file and is based on at least one of: the transaction time and/or date, transaction amount, and additional transaction data included in each transaction data entry included in the respective account profile; a generation module of the processing server configured to generate a second data file, wherein the second data file includes at least the account identifier corresponding to each of the identified account profiles; and a transmitting device of the processing server configured to electronically transmit the generated second data file.

Another system for providing insight metrics for transaction behavior includes: an account database of a processing server configured to store a plurality of account profiles, wherein each account profile includes a structured data set related to a transaction account including at least a profile identifier and a plurality of transaction data entries, each transaction data entry including data related to a payment transaction involving the related transaction account including at least a transaction time and/or date, a transaction amount, a merchant identifier, and additional transaction data; a receiving device of the processing server configured to receive a first data file, wherein the first data file includes at least a specific identifier associated with a specific merchant and an account identifier of a group of one or more account identifiers; a querying module of the processing server configured to execute a query on the account database to identify, for each account identifier of the group of one or more account identifiers, a related account profile based on a correspondence between the included profile identifier and the respective account identifier; an analytic module of the processing server configured to identify one or more metric values for each identified account profile, wherein each of the one or more metric values is associated with the one or more desired metrics included in the received first data file and is based on at least one of: the transaction time and/or date, transaction amount, and additional transaction data included in each transaction data entry included in the respective account profile; a generation module of the processing server configured to generate a second data file, wherein the second data file includes at least the account identifier corresponding to each of the identified account profiles; and a transmitting device of the processing server configured to electronically transmit the generated second data file.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for providing insight metrics to a merchant based on consumer transaction behavior in accordance with exemplary embodiments.

FIG. 2 is a block diagram illustrating the processing server of FIG. 1 for the providing of insight metrics to a merchant based on consumer transaction behavior in accordance with exemplary embodiments.

FIG. 3 is a flow diagram illustrating a process for providing a filtered list of consumers to a merchant based on consumer insight metrics using the system of FIG. 1 in accordance with exemplary embodiments.

FIG. 4 is a flow diagram illustrating a process for generating a list of consumers based on consumer insight metrics generated using consumer transaction behavior by the processing server of FIG. 2 in accordance with exemplary embodiments.

FIGS. 5 and 6 are flow charts illustrating exemplary methods for providing insight metrics for transaction behavior in accordance with exemplary embodiments.

FIG. 7 is a flow diagram illustrating the processing of a payment transaction in accordance with exemplary embodiments.

FIG. 8 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Payment Rails—Infrastructure associated with a payment network used in the processing of payment transactions and the communication of transaction messages and other similar data between the payment network and other entities interconnected with the payment network. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

### System for Providing Insight Metrics Based on Consumer Transaction Behavior

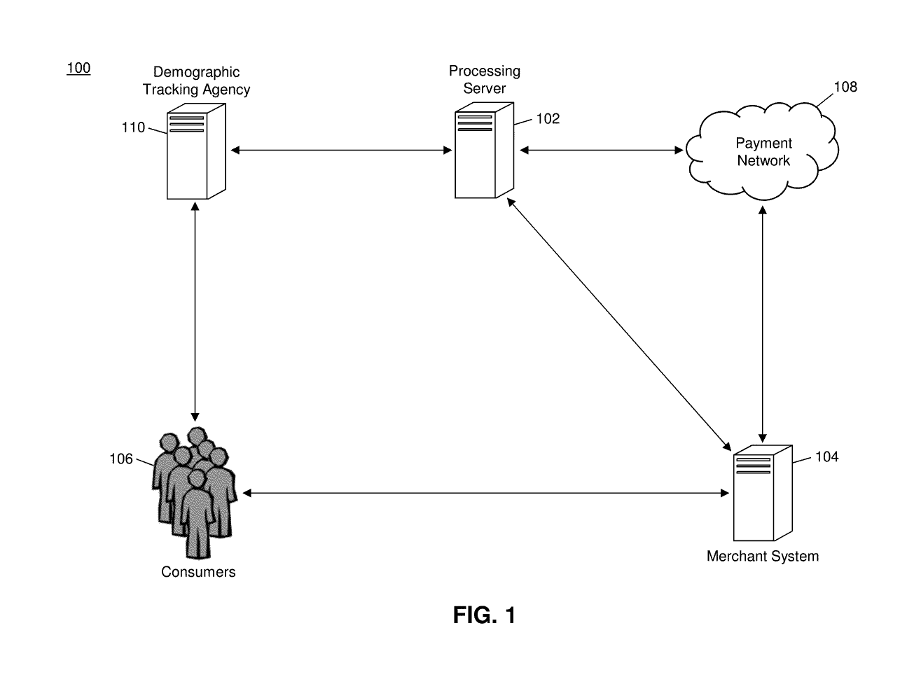

FIG. 1 illustrates a system 100 for the providing of consumer insight metrics to a merchant for customers of that merchant, where the metrics are based on transaction behavior for each consumer including payment transactions not involving the merchant.

The system 100 may include a processing server 102. The processing server 102, discussed in more detail below, may be configured to identify insight metrics for a consumer based on their transaction behavior for payment transactions involving the respective consumer. In the system 100, a merchant system 104 may participate in a plurality of payment transactions involving a plurality of different consumers 106. The merchant system 104 may be a computing system (e.g., a point of sale device and/or associated system(s)) of a merchant configured to receive payment for goods or services as part of a payment transaction. Each consumer 106 may conduct one or more payment transactions with the merchant system 104 using any suitable payment method. The merchant system 104 may utilize one or more payment networks 108 for the processing of each payment transaction involving the consumers 106 and the merchant system 104.

As part of the processing of each payment transaction, the merchant system 104 may provide transaction data for the respective transaction to the payment network 108. In some embodiments, the merchant system 104 may provide transaction data directly to the payment network 108. In other embodiments, the merchant system 104 may provide transaction data for each payment transaction to one or more intermediate entities, such as an acquiring financial institution or gateway processor, which may forward the transaction data on to the payment network 108. In some cases, the merchant system 104 or intermediate entity may specially format the transaction data for transmission to and processing by a payment network 108.

The payment network 108 may receive a transaction message for each payment transaction from the merchant system 104 or an intermediate entity via payment rails associated with the payment network 108. The transaction message may be a specially formatted data message that is formatted pursuant to one or more standards governing the exchange of financial transaction messages, such as the International Organization of Standardization's ISO 8583 standard. Each transaction message may include a message type indicator indicative of a type for the transaction message, such as an authorization request for transaction messages submitted to the payment network 108 by or on behalf of the merchant system 104 for authorization and processing. Each transaction message may also include a plurality of data elements, where each data element is configured to store transaction data for the related payment transaction. In some instances, a transaction message may include one or more bitmaps, each bitmap being configured to indicate the data elements included in the transaction message and the data stored therein.

The transaction data that may be stored in the transaction message may include any data related to the payment transaction suitable for the processing thereof, such as a transaction amount, transaction time, transaction date, geographic location, point of sale data, merchant data, consumer data, reward data, loyalty data, offer data, product data, issuer data, acquirer data, etc. The transaction data stored in the data elements of a transaction message may also include data associated with a transaction account used by a consumer 106 involved in the payment transaction used in the funding thereof, such as a primary account number, payment cryptogram, name, personal identification number, etc. Payment data may be conveyed to the merchant system 104 by a consumer 106 for inclusion in a transaction message using any suitable method, such as the reading of a magnetic stripe of a physical payment card, transmission via near field communication, display of a machine-readable code encoded with the payment data, input of the payment data into a computing device for electronic transmission to the merchant system 104, etc.

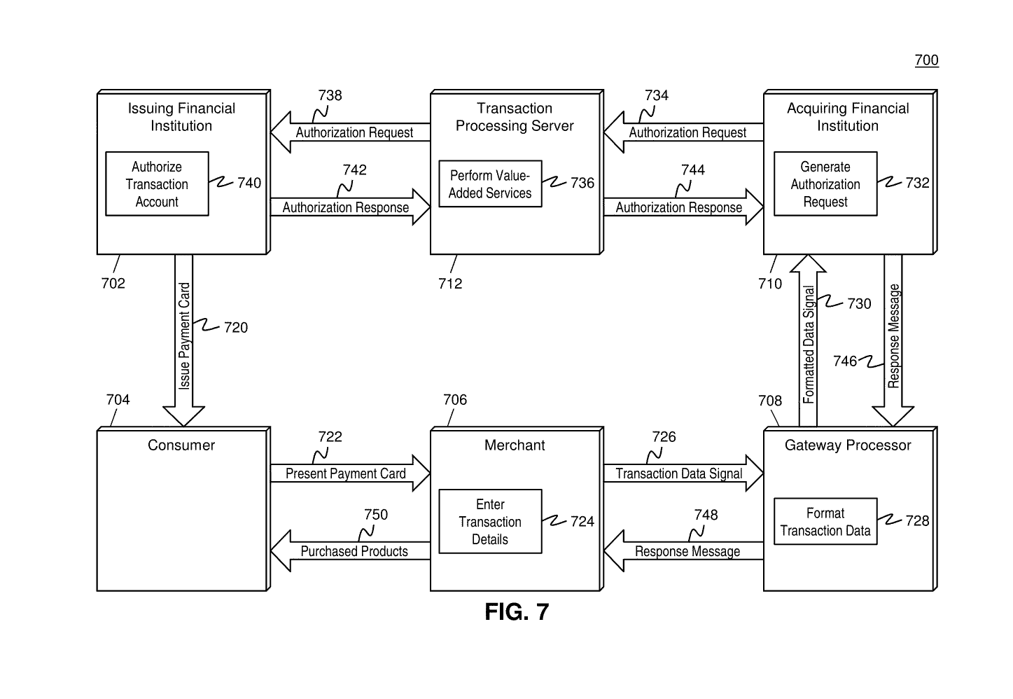

The payment network 108 may receive a transaction message for each payment transaction and may then process the respective payment transaction. The processing of a payment transaction may include, for example, forwarding the transaction message to an issuing financial institution associated with the transaction account being used to fund the payment transaction, receipt of a response message from the issuing financial institution, and forwarding of the response message back to the merchant system 104 and/or intermediate entity. The merchant system 104 may receive the response message or an indication based thereon if the transaction is approved or denied, and may finalize the transaction with the respective consumer 106 accordingly. Additional data regarding the methods and systems involved in the processing of a payment transaction are discussed in more detail below with respect to the process 700 illustrated in FIG. 7.

The processing server 102 may be configured to provide insight metrics to the merchant system 104 for one or more of the consumers 106 associated therewith based on the transaction behavior for each consumer 106. The processing server 102 may be configured to receive data from the payment network 108 for payment transactions involving each of the consumers 106. In an exemplary embodiment, the processing server 102 may be configured to receive data from the payment network 108 for payment transactions involving each consumer 106 and a plurality of different merchants, including the merchant system 104 and other merchants apart from the merchant system 104. In some instances, the processing server 102 may be a part of the payment network 108 and may receive the data as part of the internal processing of payment transactions by the payment network 108. In other instances, the payment network 108 may electronically transmit the data to the processing server 102 using a suitable communication network and method, such as via a local area network, wireless area network, a radio frequency network, the Internet, etc. The data may be transmitted to the processing server 102 as transaction messages or may be included in another suitable data format, such as any structured data set suitable for use in performing the functions discussed herein.

The processing server 102 may be configured to receive the data from the payment network 108 and store the data in one or more databases included therein, as discussed in more detail below. The data received by the processing server 102 may include a data entry for each payment transaction, where the respective data entry includes at least a transaction time and/or date, a transaction amount, a merchant identifier, and a primary account number for the payment transaction, and any additional transaction data that may be suitable for performing the functions discussed herein. The transaction time and/or date may be a time and/or date at which the payment transaction was initiated for processing by an associated merchant and/or processed by the payment network 108. The transaction amount may be an amount paid by the consumer 106 involved in the payment transaction to the merchant involved in the payment transaction. The merchant identifier may be an identification value associated with the merchant involved in the payment transaction for identification thereof, such as a merchant identification number. The primary account number may be a number associated with a transaction account used to fund the payment transaction. Additional transaction data may include, for example, a geographic location, point of sale data, consumer data, merchant data, loyalty data, reward data, offer data, product data, issuer data, acquirer data, etc.

The merchant system 104 may electronically submit a data signal superimposed or otherwise encoded with a data request to the processing server 102, requesting consumer insight metrics or data related thereto for one or more consumers 106. The processing server 102 may be configured to identify the consumer insight metrics based on the transaction data associated with each respective consumer 106 as received from the payment network(s) 108 and stored therein. The data request may include at least one or more desired metrics. The one or more desired metrics may include any metrics that may be identified by the processing server 102 based on consumer transaction behavior that may be suitable for use by the merchant system 104, such as an average transaction amount, transaction frequency, number of transactions, propensity to spend, and other data that may be identified for one or more of a plurality of different categories, such as time (e.g., per day, per week, per month, per annum, during a weekday, during a weekend, on a specific day, on a specific weekend, etc.), geographic location, weather condition, merchant (e.g., specific merchant, merchant category, merchant industry, list of specific merchants, etc.), etc., and any combination thereof. For example, the merchant system 104 may request the proportion of spend per month for consumers 106 at the merchant compared to other merchants in the same merchant industry, as well as a propensity to spend in the merchant industry for the next thirty to sixty days. In another example, a merchant system 104 may request the propensity for a consumer 106 to spend at each of a plurality of different merchant restaurant types.

In one embodiment, the data request submitted by the merchant system 104 may include a plurality of account identifiers. Each account identifier may be an identification number or other suitable value associated with a transaction account related to a consumer 106 involved in payment transactions involving the merchant system 104. In an exemplary embodiment, account identifiers may not include primary account numbers. In some cases, account identifiers may include hashed primary account numbers or other modifications to primary account numbers that may be related thereto but may not be converted back into the underlying primary account number, such that the merchant system 104 may be unable to access, retrieve, or otherwise identify a primary account number associated with a consumer 106. In such instances, privacy of the consumers 106 may be maintained.

In such an embodiment, the processing server 102 may receive the plurality of account identifiers and may identify, for each account identifier, transaction data entries for payment transactions involving the related transaction account. The processing server 102 may store each of the transaction data entries for a transaction account in an account profile, discussed in more detail below, and may also include in the account profile an account identifier associated therewith. In instances where the account identifier may be a hashed or other modification of a primary account number, the processing server 102 may be configured to generate the account identifier from the primary account number included in the transaction data for each respective payment transaction. The processing server 102 may thus identify an account profile for each account identifier received from the merchant system 104 based on the account identifier included therein.

In other embodiments, the data request submitted by the merchant system 104 may include a plurality of merchant transaction entries. Each merchant transaction entry may be a transaction data entry for a payment transaction involving a consumer 106 and the merchant system 104. The merchant transaction entry may include data related thereto, including at least a transaction time and/or date, a transaction amount, and an account identifier associated with the transaction account used to fund the related payment transaction. In some instances, the data request or each merchant transaction entry may include a merchant identifier associated with the merchant system 106. As discussed above, the account identifier may be a hash or other modification of the primary account number associated with the transaction account, or may be any other suitable identification value, such as one generated by the merchant system 104. For example, the account identifier may be an identification number used by the merchant system 104 for internal organization of merchant transaction entries. In some instances, each account identifier included in a merchant transaction entry may be included in at least two different merchant transaction entries in the data request submitted to the processing server 102.

In such an embodiment, the processing server 102 may be configured to identify an account profile for each account identifier included in the merchant transaction entries based on a correspondence in the transaction data included in the respective merchant transaction entries and included in the transaction data entries included in the respective account profile. For example, the processing server 102 may match the transaction time and/or date and transaction amount included in each merchant transaction entry including a common account identifier with the transaction time and/or date and transaction amount included in transaction data entries included in a single account profile that include the merchant identifier associated with the merchant system 104. In such an instance, the account identifier may be thus associated with the account profile.

Once the processing server 102 has identified an account profile for each account identifier, the processing server 102 may identify one or more consumer insight metrics for each account identifier. Each consumer insight metric may be a metric value identified for the respective account identifier that corresponds to the desired metrics requested by the merchant system 104. Each consumer insight metric may be identified based on corresponding transaction data included in one or more of the transaction data entries included in the associated account profile. For example, to identify a proportion of spending at the merchant associated with the merchant system 104 compared to other merchants in the merchant industry, the processing server 102 may analyze the transaction amount included in transaction data entries that include the merchant identifier associated with the merchant system 104 compared to the transaction amount included in transaction data entries that include a merchant category code associated with the merchant industry that do not include the merchant identifier.

Once the processing server 102 has identified the consumer insight metrics as requested by the merchant system 104 for each consumer 106, the processing server 102 may return a data file to the merchant system 104 via superimposition or other encoding in a data signal electronically transmitted to the merchant system 104 via a suitable communication method and system. The data file may include at least each of the account identifiers for which a related account profile was identified. In some instances, the data file may also include the one or more consumer insight metrics identified by the processing server 102 for each account identifier that correspond to the one or more desired metrics requested by the merchant system 104.

In some embodiments, the data request submitted to the processing server 102 by the merchant system 104 may also include a threshold value for at least one of the desired metrics. In such an embodiment, the processing server 102 may be configured to filter the account identifiers based on the threshold values. For example, the processing server 102 may filter out account identifiers where the corresponding consumer insight metric does not exceed (or does exceed, as applicable) the threshold value or values for the corresponding metric or metrics. The processing server 102 may only include in the data file returned to the merchant system 104 the remaining account identifiers after filtering. In an example, the merchant system 104 may request the account identifiers for their consumers 106 who have an average spend in their merchant industry above a specific threshold, and where their proportion to spend at the merchant system 104 as compared to other merchants in the same industry is below a specific threshold. The processing server 102 may thus return a list of account identifiers to the merchant system 104 that may be ideal for targeting as it may correspond to a list of accounts where the corresponding consumers 106 spend a lot in the merchant's industry, but currently spend it primarily at the merchant's competitors.

In some embodiments, the system 100 may also include a demographic tracking agency 110. The demographic tracking agency 110 may be configured to identify one or more demographic characteristics for each of the consumers 106. The demographic tracking agency 110 may identify consumer demographic characteristics using any suitable method, such as surveys, census information, credit bureau reporting data, etc. Demographic characteristics may include, for example, age, gender, zip code, postal code, municipality, income, education, occupation, residential status, familial status, marital status, etc. The demographic tracking agency 110 may be compared to electronically transmit the demographic characteristic associated with each consumer 106 to the processing server 102 for inclusion in a respective account profile. In some embodiments, the demographic characteristics may be matched to an account profile using an account identifier or other suitable identification value. For example, the demographic tracking agency 110 and processing server 102 may each hash a primary account number associated with the respective data using the same hashing algorithm, such that the demographic characteristics can be transmitted to the processing server 102 and matched to an account profile thereby without the transmission or use of a primary account number or other sensitive financial information. Methods suitable for use in the exchange and association of demographic characteristics are discussed in more detail in U.S. patent application Ser. No. 13/437,987, entitled “Protecting Privacy in Audience Creation,” filed on Apr. 3, 2012, by Curtis Villars, et al., and U.S. patent application Ser. No. 14/498,194, entitled “Method and System for Identifying Merchant Market Shares Based on Purchase Data,” filed on Sep. 26, 2014, by Susan Grossman, which are herein incorporated by reference in their entirety.

In such embodiments, the processing server 102 may be configured to incorporate the use of demographic characteristics in the identification of consumer insight metrics and the filtering thereof. For example, the merchant system 104 may request metrics that are based in part of demographic characteristics, such as the propensity to spend for the merchant's industry across a plurality if income and age groups. The processing server 102 may also be configured to filter account identifiers based on associated demographic characteristics, such as may be requested by the merchant system 104.

In some embodiments, the processing server 102 may be configured to use transaction data for more than one transaction account in the identification of consumer insight metrics for a consumer 106. In such embodiments, the processing server 102 may identify an account profile related to the account profile associated with an account identifier for which consumer insight metrics are requested. In some instances, the processing server 102 may identify related account profiles as account profiles that include demographic characteristics similar to or the same as the demographic characteristics of the account profile for which consumer insights are to be identified. In some cases, the processing server 102 may group account profiles into microsegments of account profiles, which may be segments of account profiles that are small enough for the data to retain value, but large enough such that the detain is not personally identifiable to any individual consumer 106 to protect consumer privacy. Methods and systems suitable for use in the identification of a microsegment of consumers or account profiles are discussed in more detail in U.S. patent application Ser. No. 13/437,987, entitled “Protecting Privacy in Audience Creation,” filed on Apr. 3, 2012, by Curtis Villars, et al., which is herein incorporated by reference in its entirety.

In such an embodiment, the processing server 102 may be configured to identify consumer insight metrics based on the transaction data included in the transaction data entries included in an account profile, as well as the transaction data included in the transaction data entries included in the related account profiles. In such cases, the resulting consumer insight metrics may be accurate while retaining the privacy of the consumer 106, as the consumer insight metrics may not be specific to the individual consumer 106, but to any generic consumer that is similar to the individual consumer 106. As a result, consumer privacy may be maintained, while still providing valuable consumer insight metrics to the merchant system 104, even in instances where consumer insight metrics for a single consumer 106 are requested.

Consumer insight metrics may be suitable for use by the merchant system 104 for a plurality of different uses. For instance, the merchant system 104 may use the consumer insight metrics for providing additional services to a consumer 106. For example, the merchant system 104 may be a hotel and may receive metrics regarding a consumer's propensities for various restaurant types and may use the data to provide restaurant recommendations tailored to the consumer 106 upon check-in. In another example, a merchant system 104 may reach out to its consumers 106 that are identified to shop more often with competing merchants, in order to increase the merchant's market share and consumer satisfaction. In some instances, consumer insight metrics may be used to identify offers to pass on to the consumer 106 for redemption at the merchant system 104 or other merchants, such as partnering merchants. Additional data regarding the identification of offers based on consumer insights may be found in U.S. patent application Ser. No. 14/896,076, entitled “Method and System for Real-Time Offer Optimization,” filed on Dec. 4, 2015, by Kaitlin Triano et al., which is herein incorporated by reference in its entirety.

In some embodiments, the processing server 102 may be configured to identify consumer insight metrics and provide account identifiers and/or associated insight metrics to merchant systems 104 in real-time. For example, the processing server 102 may be configured to perform the functions discussed herein for identifying consumer insight metrics and filtering account identifiers at or near real-time once a data request is received from a merchant system 104. In such an instance, the merchant system 104 may be able to receive insight metrics for a consumer 106 in or near real-time, which may be used to enhance services provided to the consumer 106 during a single interaction, such as during the check-in process at a hotel. In some embodiments, the processing server 102 may be configured to identify consumer insight metrics and/or filter account identifiers at predetermined periods of time, such as by updating the list of account identifiers for a merchant system 104 on a daily, weekly, or monthly basis. In such an instance, the merchant system 104 may be kept apprised of reactions by consumers 106 to advertisements and other actions, and may be quickly informed of consumers 106 that begin shopping at other merchants, etc.

The systems and methods discussed herein may enable the processing server 102 to provide value consumer insight metrics to the merchant system 104 for consumers 106 of the merchant system 104 that are based on transaction behavior for each consumer 106 that include payment transactions not involving the merchant system 104. As a result, the merchant system 104 may receive valuable metrics that the merchant system 104 may be unable to identify independently due to the lack of transaction information. In addition, by use of the external processing server 102, the merchant system 104 may be availed of the information without sacrificing consumer privacy. Furthermore, the use of related account profiles by the processing server 102 may even further increase consumer privacy, particularly in instances where the merchant system 104 may request metrics for a single or small number of consumers.

### Processing Server

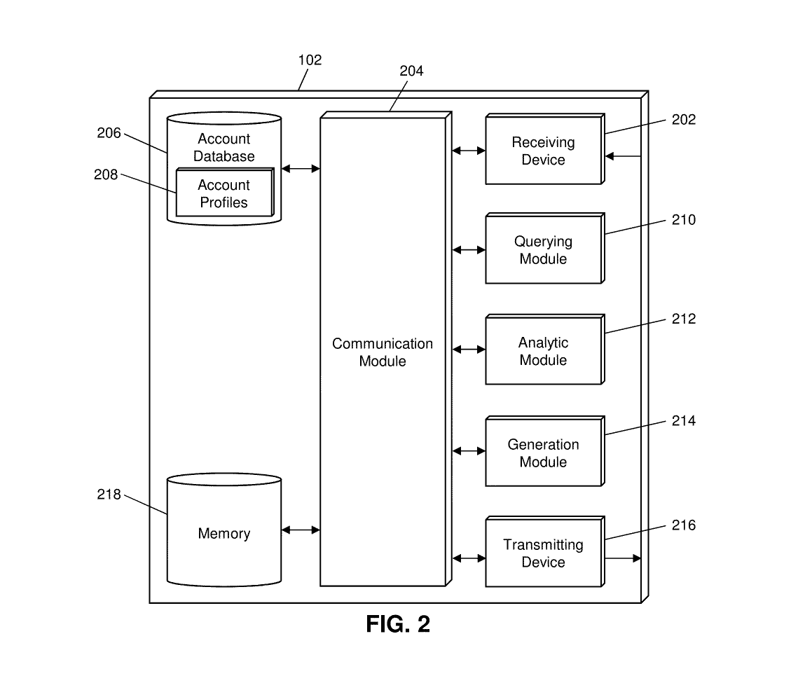

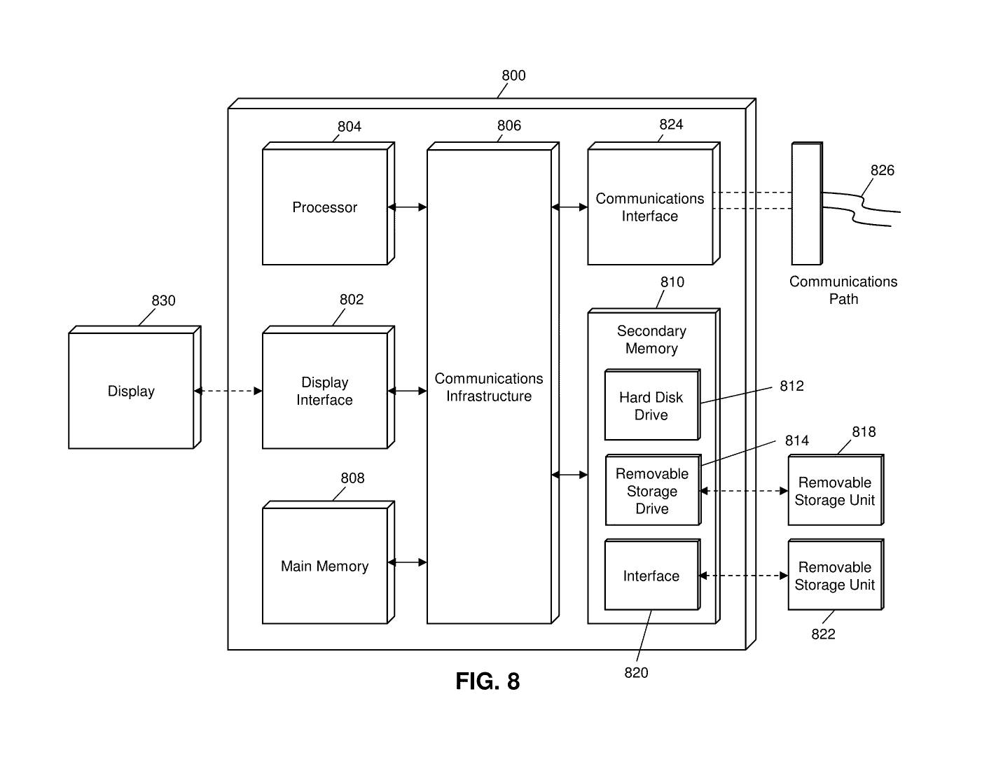

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 800 illustrated in FIG. 8 and discussed in more detail below may be a suitable configuration of the processing server 102.

The processing server 102 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 108 for the transmission of transaction messages that include sensitive financial data and information. In some instances, the receiving device 202 may also be configured to receive data from merchant systems 104, payment networks 108, demographic tracking agencies 110, and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically data signals that are transmitted, where data may be superimposed on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by payment networks 108 that may be superimposed with or otherwise encoded with transaction data associated with payment transactions. In some instances, such transaction data may be included in or may be comprised of transaction messages. The transaction messages may be formatted pursuant to one or more standards, such as the ISO 8583 standard, and include a plurality of data elements including data elements configured to store primary account numbers, transaction amounts, transaction times and/or dates, merchant identifiers, and additional transaction data. In other embodiments, the transaction data may be comprised of structured data sets including the data associated with each respective payment transaction. The receiving device 202 may also be configured to receive data signals electronically transmitted by the merchant system 104, which may be superimposed or otherwise encoded with data files. The data files may comprise a request for consumer insight metrics and/or identifiers and include one or more desired metrics, a merchant identifier, and a plurality of account identifiers or a plurality of merchant transaction entries. In some embodiments, the receiving device 202 may be configured to receive data signals electronically transmitted by demographic tracking agencies 110, which may be superimposed or otherwise encoded with demographic characteristics and associated account identifiers or other data suitable for identifying a transaction account related therewith.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 210, an analytic module 212, a generation module 214, etc. As used herein, the term “module” may be software or hardware particularly programmed to receive an input, perform one or more processes using the input, and provide an output. The input, output, and processes performed by various modules will be apparent to one skilled in the art based upon the present disclosure.

The processing server 102 may include an account database 206. The account database 206 may be configured to store a plurality of account profiles 208 using a suitable data storage format and schema. The account database 206 may be a relational database that utilizes structured query language for the storage, identification, modifying, updating, accessing, etc. of structured data sets stored therein. Each account profile 208 may be a structured data set configured to store data related to a transaction account. Each account profile 208 may include at least a plurality of transaction data entries. Each transaction data entry may include data related to a payment transaction involving the related transaction account, including at least a transaction time and/or date, transaction amount, merchant identifier, and additional transaction data, which may include a geographic location, consumer data, merchant data, point of sale data, loyalty data, reward data, offer data, product data, acquirer data, issuer data, etc. In some instances, an account profile 208 may also include an account identifier associated with the related transaction account, such as may be identified using a primary account number associated with the related transaction account, and one or more demographic characteristics, such as may be supplied by one or more demographic tracking agencies 110 (e.g., and received via the receiving device 202).

The processing server 102 may include a querying module 210. The querying module 210 may be configured to execute queries on databases to identify information. The querying module 210 may receive one or more data values or query strings, and may execute a query string based thereon on an indicated database, such as the account database 206, to identify information stored therein. The querying module 210 may then output the identified information to an appropriate engine or module of the processing server 102 as necessary. The querying module 210 may, for example, execute a query on the account database 206 to identify an account profile 208 related to an account identifier included in a data request provided by the merchant system 104 based on inclusion of the account identifier in the respective account profile 208 or inclusion of transaction data entries therein where the included merchant identifier is associated with the merchant system 104 (e.g., as included in the data request) and where the transaction time and/or date and transaction amount correspond to the time and/or date and amount included in merchant transaction entries included in the data request that include the respective account identifier. In another example, the querying module 210 may execute a query on the account database 206 to insert demographic characteristics into account profiles 208 based on the account identifiers or other identification values stored therein.

The processing server 102 may also include an analytic module 212. The analytic module 212 may be configured to identify metric values for account profiles 208 based on transaction data. The analytic module 212 may be configured to receive a desired metric and a plurality of transaction data entries as input, may calculate or otherwise identify a metric value for the desired metric, and may output the metric value to another module or engine of the processing server 102. For example, the analytic module 212 may receive a desired metric from the one or more desired metrics included in the data request received by the receiving device 202 from the merchant system 104 and the plurality of transaction data entries included in one (e.g., or more, as applicable) account profiles 208 associated with an account identifier provided by the merchant system 104 in the data request, and may identify a metric value for the desired metric based on the transaction data included in one or more of the transaction data entries. In some embodiments, the analytic module 212 may also be configured to filter account identifiers. In such an instance, the analytic module 212 may also be supplied with a threshold value for a metric and may be configured to filter the account identifiers to be provided to the merchant system 104 based thereon.

The processing server 102 may also include a generation module 212. The generation module 212 may be configured to receive one or more instructions for the generation of data, may generate the data, and may output the generated data to another module or engine of the processing server 102. In some instances, instructions for the generation of data may be accompanied by data used in the generation. For example, the generation module 212 may be configured to generate a data file that includes at least the account identifiers for which associated account profiles 208 were identified. In such an example, the generation module 212 may receive the instruction as to what is included in the data file, as well as the account identifiers to be included in the data file. In some cases, the data file may also include the metric values identified for each account identifier corresponding to the one or more desired metrics, and may also be filtered to only include account identifiers whose metric values satisfy threshold value supplied by the merchant system 104 (e.g., and included in the data request received via the receiving device 202).

The processing server 102 may also include a transmitting device 216. The transmitting device 216 may be configured to transmit data over one or more networks via one or more network protocols. In some embodiments, the transmitting device 216 may be configured to transmit data over the payment rails, such as using specially configured infrastructure associated with payment networks 108 for the transmission of transaction messages that include sensitive financial data and information, such as identified payment credentials. In some instances, the transmitting device 216 may be configured to transmit data to merchant systems 104, payment networks 108, demographic tracking agencies 110, and other entities via alternative networks, such as the Internet. In some embodiments, the transmitting device 216 may be comprised of multiple devices, such as different transmitting devices for transmitting data over different networks, such as a first transmitting device for transmitting data over the payment rails and a second transmitting device for transmitting data over the Internet. The transmitting device 216 may electronically transmit data signals that have data superimposed that may be parsed by a receiving computing device. In some instances, the transmitting device 216 may include one or more modules for superimposing, encoding, or otherwise formatting data into data signals suitable for transmission.

The transmitting device 216 may be configured to electronically transmit data signals to merchant systems 104 that are superimposed or otherwise encoded with data files that include responses to data requests. The responses may include the account identifiers that are identified as being associated with an account profile 208 stored in the account database 206, which may be filtered as requested by the merchant system 104. In some instances, the account identifiers may be accompanied by the metric values identified for the account identifier via the analytic module 212 based on the associated transaction data.

The processing server 102 may also include a memory 220. The memory 220 may be configured to store data for use by the processing server 102 in performing the functions discussed herein. The memory 220 may be configured to store data using suitable data formatting methods and schema and may be any suitable type of memory, such as read-only memory, random access memory, etc. The memory 220 may include, for example, currency and geographic location associations, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art.

### Process for Providing a Filtered Consumer List Based on Consumer Insights

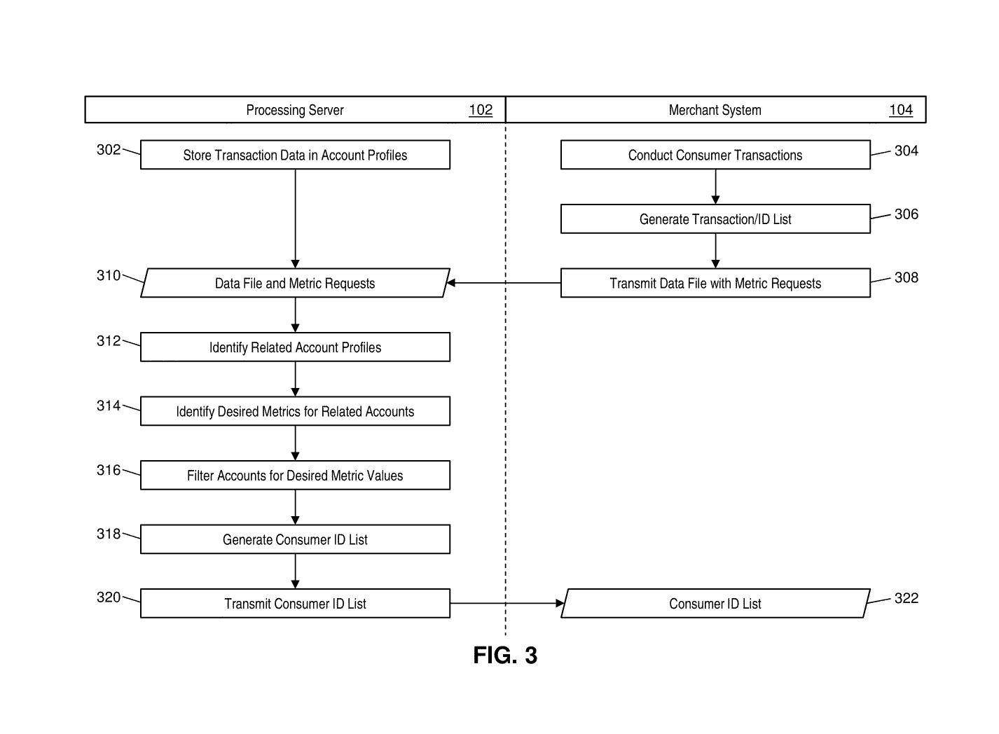

FIG. 3 illustrates a process for the providing of a filtered consumer list to the merchant system 104 by the processing server 102 based on consumer metric insights identified via transaction behavior of the associated consumers 106.

In step 302, the processing server 102 may store transaction data in the account database 206 via the storage of a plurality of transaction data entries in each of a plurality account profiles 208, where each account profile 208 includes transaction data entries involving the related transaction account. Each transaction data entry may include at least a transaction time and/or date, transaction amount, merchant identifier, and additional transaction data. In some instances, each account profile 208 may further include an account identifier associated therewith. In some cases, the account identifier may be different from the primary account number associated with the related transaction account and may, in some instances, be generated using the primary account number, such as a hashing thereof.

In step 304, the merchant system 104 may conduct a plurality of payment transactions involving a plurality of different consumers 106. The payment transactions may be processed via one or more payment networks 108, which may be configured to provide transaction data associated therewith to the processing server 102 (e.g., for storage in the account database 206, as in step 302). The merchant system 104 may associate each payment transaction with an account identifier associated with the consumer 106 or transaction account used in the respective payment transaction. In some instances, the account identifier may be generated using the primary account number associated with the transaction account, such as a hashing thereof, or may be identified by the merchant system 104 using any suitable method. In step 306, the merchant system 104 may generate a list of transactions or account identifiers, as may be applicable for requesting consumer insight metrics. Transactions included in the list of transactions may include at least a transaction time and/or date, transaction amount, and account identifier. The list of transactions or account identifiers may be included in a data file, which may also include a merchant identifier associated with the merchant system 104 and one or more desired metrics. In some instances, the data file may also include one or more threshold values, each of which may be associated with one of the one or more desired metrics.

In step 308, the merchant system 104 may electronically transmit the data file that includes the list of transactions or account identifiers and desired metrics to the processing server 102 using a suitable communication network and method, such as the Internet. In step 310, the receiving device 202 of the processing server 102 may receive the data signal superimposed or otherwise encoded with the data file and parse the data included therein. In step 312, the querying module 210 of the processing server 102 may execute a query on the account database 206 to identify an account profile 208 associated with each of the account identifiers included in the data file received from the merchant system 104. In instances where the data file includes a list of account identifiers, the associated account profiles 208 may be identified based on an inclusion of the respective account identifier in the account profile 208. In instances where the data file includes a list of transactions, an associated account profile 208 may be identified based on the inclusion of transaction data entries that include the merchant identifier included in the data file that include a transaction time and/or date and transaction amount that correspond to the transaction time and/or date and transaction amount in transactions in the list of transactions that also include the respective account identifier.

In step 314, the analytic module 212 of the processing server 102 may identify a metric value for each of the one or more desired metrics for each of the account identifiers for which an associated account profile 208 was identified. The metric value may be based on the transaction time and/or date, transaction amount, and/or additional transaction data included in one or more of the transaction data entries included in the respective account profile 208. The data used in the identification of the metric value may be based on the desired metric. For example, if the desired metric is associated with a specific merchant or merchant industry, transaction data entries for payment transactions involving that specific merchant (e.g., via an associated merchant identifier) or merchant industry (e.g., via an associated merchant category code) may be used by the analytic module 212. In some embodiments, the analytic module 212 may also use transaction data entries included in one or more account profiles 208 related to the account profile 208 associated with the respective account identifier, such as may be identified via associated demographic characteristics or similar transaction behaviors. In some cases, the use of related account profiles may be based on the number of account identifiers included in the list of accounts or transactions.

In step 316, the analytic module 212 of the processing server 102 or other suitable module or engine of the processing server 102 may filter the account identifiers, if applicable. The account identifiers may be filtered if the data file submitted by the merchant system 104 includes one or more threshold values for use thereof. The analytic module 212 may filter out any account identifiers whose corresponding metric values do not satisfy (or do, as applicable) the threshold value for the corresponding metric value. In step 318, the generation module 214 of the processing server 102 may generate a data file that includes the remaining account identifiers after the filtering. In some embodiments, the data file may also include the metric values associated with each of the remaining account identifiers. In step 320, the transmitting device 216 of the processing server 102 may electronically transmit a data signal superimposed or otherwise encoded with the data file including the account identifiers to the merchant system 104. In step 322, the merchant system 104 may receive the list of account identifiers filtered for the desired metrics and values and may utilize it accordingly, such as for targeted advertising, content distribution, or other suitable use as will be apparent to persons having skill in the relevant art.

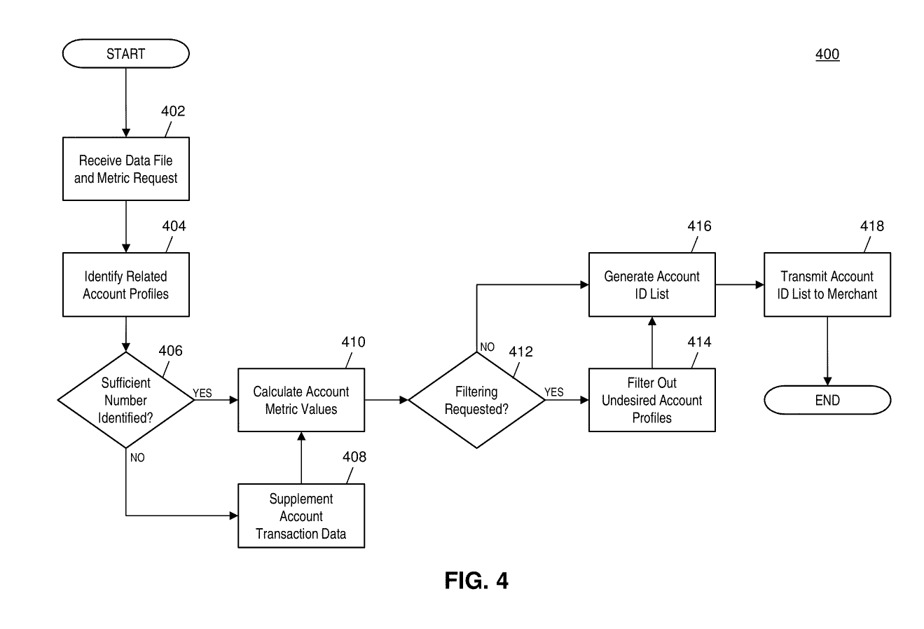

FIG. 4 illustrates a process 400 for the providing of an account identifier list to the merchant system 104 by the processing server 102 based on consumer metric insights identified via transaction behavior of the associated consumers 106.

In step 402, the receiving device 202 of the processing server 102 may receive a data signal electronically transmitted by the merchant system 104 that is superimposed or otherwise encoded with a data file that includes a list of account identifiers or merchant transaction entries, a merchant identifier associated with the merchant system 104, and a metric request for one or more desired metrics. In some instances, the metric request may also include a threshold value for at least one of the one or more desired metrics. In instances where the data file includes a list of merchant transaction entries, each transaction entry may include data related to a payment transaction involving the merchant system 104 and include at least a transaction time and/or date, transaction amount, and an account identifier.

In step 404, the querying module 210 of the processing server 102 may execute a query on the account database 206 to identify an account profile 208 associated with each account identifier included in the data file. In instances where the data file includes a list of account identifiers, the querying module 210 may identify an account profile 208 for each account identifier that includes the respective account identifier. In instances where the data file includes a list of merchant transaction entries, the querying module 210 may identify an account profile 208 for each account identifier that includes transaction data entries that include the merchant identifier associated with the merchant industry 104 that include a transaction time and/or date and transaction amount that correspond to the transaction time and/or date and transaction amount in the merchant transaction entries that include the respective account identifier.

In step 406, the processing server 102 may determine if a sufficient number of account profiles 208 that are associated with account identifiers have been identified, such that the resulting list of account identifiers protects the privacy of the associated consumers 106. In some instances, the number identified for sufficiency may be identified by the merchant system 104, the processing server 102, a regulatory agency, or other suitable entity. For example, the processing server 102 may require at least one hundred account profiles 208 to be identified in order to protect consumer privacy, but could be more or less (e.g., ten account profiles 208, a thousand account profiles 208, ten thousand account profiles 208, etc., such as depending on a number of data points that may be used to identify a specific consumer 106). If the processing server 408 determines that the number of identified account profiles 208 is not sufficient, then, in step 408, the processing server 102 may supplement the data included in each of the identified account profiles with transaction data entries included in related account profiles 208, such that the transaction data used in the identification of consumer insight metrics is related to, but not specific to, the associated consumer 106. The related account profiles 208 may be identified based on the inclusion of similar demographic characteristics, similar transaction behavior, or other criteria.

If, in step 406, the number of account profiles 208 are sufficient to protect consumer privacy, or if the account profiles 208 have been supplemented with transaction data for the protection of consumer privacy, then, in step 410, the analytic module 212 of the processing server 102 may identify, for each account identifier, account metric values. Each account metric value may correspond to one of the one or more desired metrics included in the data file submitted by the merchant system 104, and may be identified based on the transaction time and/or date, transaction amount, and/or additional transaction data included in one or more transaction data entries included the associated account profile 208.

In step 412, the processing server 102 may determine if filtering of the account identifiers is requested by the merchant system 104. The determination may be based on the inclusion of threshold values in the data file submitted by the merchant system 104 and received by the receiving device 202 of the processing server 102 in step 402. If it is determined that filtering is being requested, then, in step 414, the analytic module 212 or other suitable module or engine of the processing server 102 may filter out the account identifiers that do not (or do, as applicable) satisfy the threshold values based on the threshold values and the corresponding account metric values identified for the respective account identifier. In some embodiments, the processing server 102 may once again determine if the number of account identifiers is sufficient, such as determined in step 406, discussed above, after the filtering has occurred. If the number is no longer sufficient due to the filtering, the process may return to step 408 for supplementing of the transaction data for each account identifier.

Once the account identifiers have been filtered, or if no filtering of the account identifiers was requested, then, in step 416, the generation module 214 of the processing server 102 may generate a data file that includes a list of the account identifiers. In instances where no filtering was performed, the list may include all account identifiers where an associated account profile 208 was identified. In instances where filtering was performed, the list may include all account identifiers that remained subsequent to the filtering. In some embodiments, the data file may also include the metric values identified for each account identifier for each of the one or more desired metrics. In step 418, the transmitting device 216 of the processing server 102 may electronically transmit a data signal superimposed or otherwise encoded with the generated data file to the merchant system 104 using a suitable communication network and method.

### First Exemplary Method for Providing Insight Metrics for Transaction Behavior

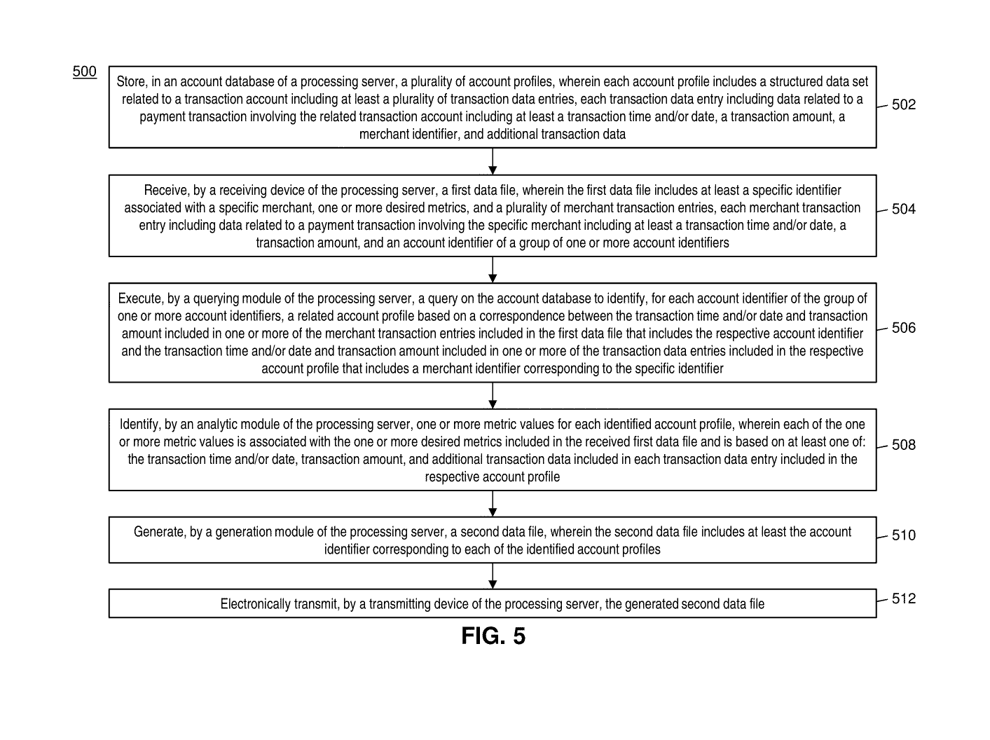

FIG. 5 illustrates a method 500 for the providing of insight metrics for transaction behavior based on the matching of transaction entries to identify account profiles for the identification of insight metrics.

In step 502, a plurality of account profiles (e.g., account profiles 208) may be stored in an account database (e.g., the account database 206) of a processing server (e.g., the processing server 102), wherein each account profile includes a structured data set related to a transaction account including at least a plurality of transaction data entries, each transaction data entry including data related to a payment transaction involving the related transaction account including at least a transaction time and/or date, a transaction amount, a merchant identifier, and additional transaction data. In step 504, a first data file may be received by a receiving device (e.g., the receiving device 202) of the processing server, wherein the first data file includes at least a specific identifier associated with a specific merchant (e.g., the merchant system 104), one or more desired metrics, and a plurality of merchant transaction entries, each merchant transaction entry including data related to a payment transaction involving the specific merchant including at least a transaction time and/or date, a transaction amount, and an account identifier of a group of one or more account identifiers.

In step 506, a query may be executed on the account database by a querying module (e.g., the querying module 210) of the processing server to identify, for each account identifier of the group of one or more account identifiers, a related account profile based on a correspondence between the transaction time and/or date and transaction amount included in one or more of the merchant transaction entries included in the first data file that includes the respective account identifier and the transaction time and/or date and transaction amount included in one or more of the transaction data entries included in the respective account profile that includes a merchant identifier corresponding to the specific identifier. In step 508, one or more metric values may be identified by an analytic module (e.g., the analytic module 212) of the processing server for each identified account profile, wherein each of the one or more metric values is associated with the one or more desired metrics included in the received first data file and is based on at least one of: the transaction time and/or date, transaction amount, and additional transaction data included in each transaction data entry included in the respective account profile.

In step 510, a second data file may be generated by a generation module (e.g., the generation module 214) of the processing server, wherein the second data file includes at least the account identifier corresponding to each of the identified account profiles. In step 512, the generated second data file may be electronically transmitted by a transmitting device (e.g., the transmitting device 216) of the processing server.

In one embodiment, the second data file may further include the one or more metric values identified for each account identifier included in the second data file. In some embodiments, the first data file may further include a threshold value associated with each of the one or more desired metrics, and the account identifiers included in the second data file may be filtered to include only account identifiers where the corresponding identified one or more metric values exceed the threshold value associated with each of the respective associated desired metrics. In a further embodiment, the second data file may further include the one or more metric values for each account identifier included in the second data file subsequent to the filtering of the account identifiers.

In one embodiment, the one or more metric values identified for each account profile may be further based on at least one of: the transaction time and/or date, transaction amount, and additional transaction data included in one or more transaction data entries included in one or more related account profiles. In a further embodiment, the group of one or more account identifiers may include a single account identifier, each account profile may further include one or more demographic characteristics, and the one or more demographic characteristics included in each of the one or more related account profiles may correspond to the one or more demographic characteristics included in an account profile corresponding to the single account identifier.

### Second Exemplary Method for Providing Insight Metrics for Transaction Behavior

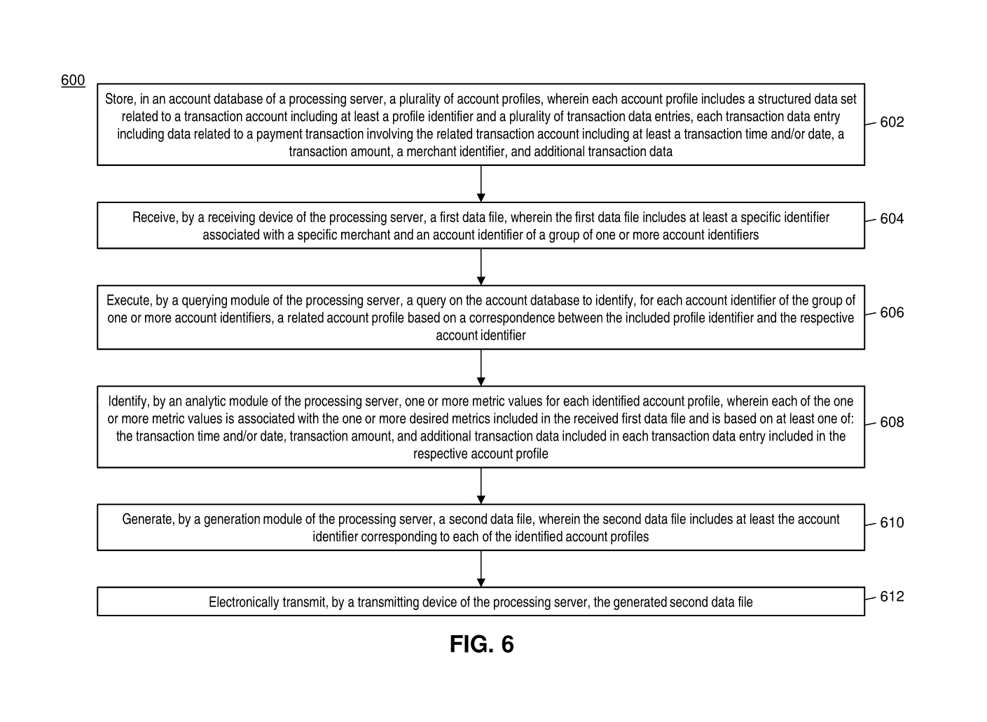

FIG. 6 illustrates a method 600 for the providing of insight metrics for transaction behavior based on the matching of merchant account identifiers to identify account profiles for the identification of insight metrics.

In step 602, a plurality of account profiles (e.g., account profiles 208) may be stored in an account database (e.g., the account database 206) of a processing server (e.g., the processing server 102), wherein each account profile includes a structured data set related to a transaction account including at least a profile identifier and a plurality of transaction data entries, each transaction data entry including data related to a payment transaction involving the related transaction account including at least a transaction time and/or date, a transaction amount, a merchant identifier, and additional transaction data. In step 604, a first data file may be received by a receiving device (e.g., the receiving device 202) of the processing server, wherein the first data file includes at least a specific identifier associated with a specific merchant (e.g., the merchant system 104) and an account identifier of a group of one or more account identifiers.

In step 606, a query may be executed on the account database by a querying module (e.g., the querying module 210) of the processing server to identify, for each account identifier of the group of one or more account identifiers, a related account profile based on a correspondence between the included profile identifier and the respective account identifier. In step 608, one or more metric values may be identified for each identified account profile by an analytic module (e.g., the analytic module 212) of the processing server, wherein each of the one or more metric values is associated with the one or more desired metrics included in the received first data file and is based on at least one of: the transaction time and/or date, transaction amount, and additional transaction data included in each transaction data entry included in the respective account profile.

In step 610, a second data file may be generated by a generation module (e.g., the generation module 214) of the processing server, wherein the second data file includes at least the account identifier corresponding to each of the identified account profiles. In step 612, the generated second data file may be electronically transmitted by a transmitting device (e.g., the transmitting device 216) of the processing server.

In one embodiment, the one or more metric values may be further based on a correspondence between the transaction time and/or date, transaction amount, and additional transaction data included in each transaction data entry included in the respective account profile that includes a merchant identifier corresponding to the specific merchant identifier and the transaction time and/or date, transaction amount, and additional transaction data included in each transaction data entry included in the respective account profile that includes a merchant identifier that does not correspond to the specific merchant identifier. In some embodiments, the second data file may further include the one or more metric values identified for each account identifier included in the second data file.

In one embodiment, the first data file may further include a threshold value associated with each of the one or more desired metrics, and the account identifiers included in the second data file may be filtered to include only account identifiers where the corresponding identified one or more metric values exceed the threshold value associated with each of the respective associated desired metrics. In a further embodiment, the second data file may further include the one or more metric values for each account identifier included in the second data file subsequent to the filtering of the account identifiers.

In some embodiments, the one or more metric values identified for each account profile may be further based on at least one of: the transaction time and/or date, transaction amount, and additional transaction data included in one or more transaction data entries included in one or more related account profiles. In a further embodiment, the group of one or more account identifiers may include a single account identifier, each account profile may further include one or more demographic characteristics, and the one or more demographic characteristics included in each of the one or more related account profiles may correspond to the one or more demographic characteristics included in an account profile corresponding to the single account identifier.

### Payment Transaction Processing System and Process

FIG. 7 illustrates a transaction processing system and a process 700 for the processing of payment transactions in the system. The process 700 and steps included therein may be performed by one or more components of the system 100 discussed above, such as the processing server 102, merchant system 104, consumers 106, payment network 108, etc. The processing of payment transactions using the system and process 700 illustrated in FIG. 7 and discussed below may utilize the payment rails, which may be comprised of the computing devices and infrastructure utilized to perform the steps of the process 700 as specially configured and programmed by the entities discussed below, including the transaction processing server 712, which may be associated with one or more payment networks configured to processing payment transactions. It will be apparent to persons having skill in the relevant art that the process 700 may be incorporated into the processes illustrated in FIGS. 3-6, discussed above, with respect to the step or steps involved in the processing of a payment transaction. In addition, the entities discussed herein for performing the process 700 may include one or more computing devices or systems configured to perform the functions discussed below. For instance, the merchant 706 may be comprised of one or more point of sale devices, a local communication network, a computing server, and other devices configured to perform the functions discussed below.

In step 720, an issuing financial institution 702 may issue a payment card or other suitable payment instrument to a consumer 704. The issuing financial institution may be a financial institution, such as a bank, or other suitable type of entity that administers and manages payment accounts and/or payment instruments for use with payment accounts that can be used to fund payment transactions. The consumer 704 may have a transaction account with the issuing financial institution 702 for which the issued payment card is associated, such that, when used in a payment transaction, the payment transaction is funded by the associated transaction account. In some embodiments, the payment card may be issued to the consumer 704 physically. In other embodiments, the payment card may be a virtual payment card or otherwise provisioned to the consumer 704 in an electronic format.

In step 722, the consumer 704 may present the issued payment card to a merchant 706 for use in funding a payment transaction. The merchant 706 may be a business, another consumer, or any entity that may engage in a payment transaction with the consumer 704. The payment card may be presented by the consumer 704 via providing the physical card to the merchant 706, electronically transmitting (e.g., via near field communication, wireless transmission, or other suitable electronic transmission type and protocol) payment details for the payment card, or initiating transmission of payment details to the merchant 706 via a third party. The merchant 706 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 724, the merchant 706 may enter transaction details into a point of sale computing system. The transaction details may include the payment details provided by the consumer 704 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 706 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 706 may be an online retailer in an e-commerce transaction. In such embodiments, the transaction details may be entered in a shopping cart or other repository for storing transaction data in an electronic transaction as will be apparent to persons having skill in the relevant art.

In step 726, the merchant 706 may electronically transmit a data signal superimposed with transaction data to a gateway processor 708. The gateway processor 708 may be an entity configured to receive transaction details from a merchant 706 for formatting and transmission to an acquiring financial institution 710. In some instances, a gateway processor 708 may be associated with a plurality of merchants 706 and a plurality of acquiring financial institutions 710. In such instances, the gateway processor 708 may receive transaction details for a plurality of different transactions involving various merchants, which may be forwarded on to appropriate acquiring financial institutions 710. By having relationships with multiple acquiring financial institutions 710 and having the requisite infrastructure to communicate with financial institutions using the payment rails, such as using application programming interfaces associated with the gateway processor 708 or financial institutions used for the submission, receipt, and retrieval of data, a gateway processor 708 may act as an intermediary for a merchant 706 to be able to conduct payment transactions via a single communication channel and format with the gateway processor 708, without having to maintain relationships with multiple acquiring financial institutions 710 and payment processors and the hardware associated thereto. Acquiring financial institutions 710 may be financial institutions, such as banks, or other entities that administers and manages payment accounts and/or payment instruments for use with payment accounts. In some instances, acquiring financial institutions 710 may manage transaction accounts for merchants 706. In some cases, a single financial institution may operate as both an issuing financial institution 702 and an acquiring financial institution 710.

The data signal transmitted from the merchant 706 to the gateway processor 708 may be superimposed with the transaction details for the payment transaction, which may be formatted based on one or more standards. In some embodiments, the standards may be set forth by the gateway processor 708, which may use a unique, proprietary format for the transmission of transaction data to/from the gateway processor 708. In other embodiments, a public standard may be used, such as the International Organization for Standardization's ISO 8783 standard. The standard may indicate the types of data that may be included, the formatting of the data, how the data is to be stored and transmitted, and other criteria for the transmission of the transaction data to the gateway processor 708.

In step 728, the gateway processor 708 may parse the transaction data signal to obtain the transaction data superimposed thereon and may format the transaction data as necessary. The formatting of the transaction data may be performed by the gateway processor 708 based on the proprietary standards of the gateway processor 708 or an acquiring financial institution 710 associated with the payment transaction. The proprietary standards may specify the type of data included in the transaction data and the format for storage and transmission of the data. The acquiring financial institution 710 may be identified by the gateway processor 708 using the transaction data, such as by parsing the transaction data (e.g., deconstructing into data elements) to obtain an account identifier included therein associated with the acquiring financial institution 710. In some instances, the gateway processor 708 may then format the transaction data based on the identified acquiring financial institution 710, such as to comply with standards of formatting specified by the acquiring financial institution 710. In some embodiments, the identified acquiring financial institution 710 may be associated with the merchant 706 involved in the payment transaction, and, in some cases, may manage a transaction account associated with the merchant 706.

In step 730, the gateway processor 708 may electronically transmit a data signal superimposed with the formatted transaction data to the identified acquiring financial institution 710. The acquiring financial institution 710 may receive the data signal and parse the signal to obtain the formatted transaction data superimposed thereon. In step 732, the acquiring financial institution may generate an authorization request for the payment transaction based on the formatted transaction data. The authorization request may be a specially formatted transaction message that is formatted pursuant to one or more standards, such as the ISO 8783 standard and standards set forth by a payment processor used to process the payment transaction, such as a payment network. The authorization request may be a transaction message that includes a message type indicator indicative of an authorization request, which may indicate that the merchant 706 involved in the payment transaction is requesting payment or a promise of payment from the issuing financial institution 702 for the transaction. The authorization request may include a plurality of data elements, each data element being configured to store data as set forth in the associated standards, such as for storing an account number, application cryptogram, transaction amount, issuing financial institution 702 information, etc.

In step 734, the acquiring financial institution 710 may electronically transmit the authorization request to a transaction processing server 712 for processing. The transaction processing server 712 may be comprised of one or more computing devices as part of a payment network configured to process payment transactions. In some embodiments, the authorization request may be transmitted by a transaction processor at the acquiring financial institution 710 or other entity associated with the acquiring financial institution. The transaction processor may be one or more computing devices that include a plurality of communication channels for communication with the transaction processing server 712 for the transmission of transaction messages and other data to and from the transaction processing server 712. In some embodiments, the payment network associated with the transaction processing server 712 may own or operate each transaction processor such that the payment network may maintain control over the communication of transaction messages to and from the transaction processing server 712 for network and informational security.

In step 736, the transaction processing server 712 may perform value-added services for the payment transaction. Value-added services may be services specified by the issuing financial institution 702 that may provide additional value to the issuing financial institution 702 or the consumer 704 in the processing of payment transactions. Value-added services may include, for example, fraud scoring, transaction or account controls, account number mapping, offer redemption, loyalty processing, etc. For instance, when the transaction processing server 712 receives the transaction, a fraud score for the transaction may be calculated based on the data included therein and one or more fraud scoring algorithms and/or engines. In some instances, the transaction processing server 712 may first identify the issuing financial institution 702 associated with the transaction, and then identify any services indicated by the issuing financial institution 702 to be performed. The issuing financial institution 702 may be identified, for example, by data included in a specific data element included in the authorization request, such as an issuer identification number. In another example, the issuing financial institution 702 may be identified by the primary account number stored in the authorization request, such as by using a portion of the primary account number (e.g., a bank identification number) for identification.

In step 738, the transaction processing server 712 may electronically transmit the authorization request to the issuing financial institution 702. In some instances, the authorization request may be modified, or additional data included in or transmitted accompanying the authorization request as a result of the performance of value-added services by the transaction processing server 712. In some embodiments, the authorization request may be transmitted to a transaction processor (e.g., owned or operated by the transaction processing server 712) situated at the issuing financial institution 702 or an entity associated thereof, which may forward the authorization request to the issuing financial institution 702.

In step 740, the issuing financial institution 702 may authorize the transaction account for payment of the payment transaction. The authorization may be based on an available credit amount for the transaction account and the transaction amount for the payment transaction, fraud scores provided by the transaction processing server 712, and other considerations that will be apparent to persons having skill in the relevant art. The issuing financial institution 702 may modify the authorization request to include a response code indicating approval (e.g., or denial if the transaction is to be denied) of the payment transaction. The issuing financial institution 702 may also modify a message type indicator for the transaction message to indicate that the transaction message is changed to be an authorization response. In step 742, the issuing financial institution 702 may transmit (e.g., via a transaction processor) the authorization response to the transaction processing server 712.

In step 744, the transaction processing server 712 may forward the authorization response to the acquiring financial institution 710 (e.g., via a transaction processor). In step 746, the acquiring financial institution may generate a response message indicating approval or denial of the payment transaction as indicated in the response code of the authorization response, and may transmit the response message to the gateway processor 708 using the standards and protocols set forth by the gateway processor 708. In step 748, the gateway processor 708 may forward the response message to the merchant 706 using the appropriate standards and protocols. In step 770, assuming the transaction was approved, the merchant 706 may then provide the products purchased by the consumer 704 as part of the payment transaction to the consumer 704.

In some embodiments, once the process 700 has completed, payment from the issuing financial institution 702 to the acquiring financial institution 710 may be performed. In some instances, the payment may be made immediately or within one business day. In other instances, the payment may be made after a period of time, and in response to the submission of a clearing request from the acquiring financial institution 710 to the issuing financial institution 702 via the transaction processing server 702. In such instances, clearing requests for multiple payment transactions may be aggregated into a single clearing request, which may be used by the transaction processing server 712 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 740), the transaction processing server 712 may be configured to perform authorization of transactions on behalf of the issuing financial institution 702. Such actions may be referred to as “stand-in processing,” where the transaction processing server “stands in” as the issuing financial institution 702. In such instances, the transaction processing server 712 may utilize rules set forth by the issuing financial institution 702 to determine approval or denial of the payment transaction, and may modify the transaction message accordingly prior to forwarding to the acquiring financial institution 710 in step 744. The transaction processing server 712 may retain data associated with transactions for which the transaction processing server 712 stands in, and may transmit the retained data to the issuing financial institution 702 once communication is reestablished. The issuing financial institution 702 may then process transaction accounts accordingly to accommodate for the time of lost communication.

In another example, if the transaction processing server 712 is unavailable for submission of the authorization request by the acquiring financial institution 710, then the transaction processor at the acquiring financial institution 710 may be configured to perform the processing of the transaction processing server 712 and the issuing financial institution 702. The transaction processor may include rules and data suitable for use in making a determination of approval or denial of the payment transaction based on the data included therein. For instance, the issuing financial institution 702 and/or transaction processing server 712 may set limits on transaction type, transaction amount, etc. that may be stored in the transaction processor and used to determine approval or denial of a payment transaction based thereon. In such instances, the acquiring financial institution 710 may receive an authorization response for the payment transaction even if the transaction processing server 712 is unavailable, ensuring that transactions are processed and no downtime is experienced even in instances where communication is unavailable. In such cases, the transaction processor may store transaction details for the payment transactions, which may be transmitted to the transaction processing server 712 (e.g., and from there to the associated issuing financial institutions 702) once communication is reestablished.

In some embodiments, transaction processors may be configured to include a plurality of different communication channels, which may utilize multiple communication cards and/or devices, to communicate with the transaction processing server 712 for the sending and receiving of transaction messages. For example, a transaction processor may be comprised of multiple computing devices, each having multiple communication ports that are connected to the transaction processing server 712. In such embodiments, the transaction processor may cycle through the communication channels when transmitting transaction messages to the transaction processing server 712, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 710 may identify that an authorization request involves an issuing financial institution 702 (e.g., via the bank identification number included in the transaction message) for which no value-added services are required. The transaction processor at the acquiring financial institution 710 may then transmit the authorization request directly to the transaction processor at the issuing financial institution 702 (e.g., without the authorization request passing through the transaction processing server 712), where the issuing financial institution 702 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 712 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 708, acquiring financial institution 710, etc.) for processing using this advanced network, and to quickly and efficiently receive a response regarding the ability for a consumer 704 to fund the payment transaction.

### Computer System Architecture

FIG. 8 illustrates a computer system 800 in which embodiments of the present disclosure, or portions thereof, may be implemented as computer-readable code. For example, the processing server 102 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-7.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device specifically configured to perform the functions discussed herein. The processor device 804 may be connected to a communications infrastructure 806, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive or universal serial bus port, the removable storage unit 818 may be a floppy disk or portable flash drive, respectively. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

Data stored in the computer system 800 (e.g., in the main memory 808 and/or the secondary memory 810) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

The computer system 800 may further include a display interface 802. The display interface 802 may be configured to allow data to be transferred between the computer system 800 and external display 830. Exemplary display interfaces 802 may include high-definition multimedia interface (HDMI), digital visual interface (DVI), video graphics array (VGA), etc. The display 830 may be any suitable type of display for displaying data transmitted via the display interface 802 of the computer system 800, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 808 and secondary memory 810, which may be memory semiconductors (e.g., DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 3-7, as discussed herein. Accordingly, such computer programs may represent controllers of the computer system 800. Where the present disclosure is implemented using software, the software may be stored in a computer program product and loaded into the computer system 800 using the removable storage drive 814, interface 820, and hard disk drive 812, or communications interface 824.

The processor device 804 may comprise one or more modules or engines configured to perform the functions of the computer system 800. Each of the modules or engines may be implemented using hardware and, in some instances, may also utilize software, such as corresponding to program code and/or programs stored in the main memory 808 or secondary memory 810. In such instances, program code may be compiled by the processor device 804 (e.g., by a compiling module or engine) prior to execution by the hardware of the computer system 800. For example, the program code may be source code written in a programming language that is translated into a lower level language, such as assembly language or machine code, for execution by the processor device 804 and/or any additional hardware components of the computer system 800. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 800 to perform the functions disclosed herein. It will be apparent to persons having skill in the relevant art that such processes result in the computer system 800 being a specially configured computer system 800 uniquely programmed to perform the functions discussed above.

Techniques consistent with the present disclosure provide, among other features, systems and methods for providing insight metrics for transaction behavior. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for providing insight metrics for transaction behavior, comprising:
storing, in an account database of a processing server, a plurality of account profiles, wherein each account profile includes a structured data set related to a transaction account including at least a plurality of transaction data entries, each transaction data entry including data related to a payment transaction involving the related transaction account including at least a transaction time and/or date, a transaction amount, a merchant identifier, and additional transaction data;
receiving, by a receiving device of the processing server, a first data file, wherein the first data file includes at least a specific identifier associated with a specific merchant, one or more desired metrics, and a plurality of merchant transaction entries, each merchant transaction entry including data related to a payment transaction involving the specific merchant including at least a transaction time and/or date, a transaction amount, and an account identifier of a group of one or more account identifiers;
executing, by a querying module of the processing server, a query on the account database to identify, for each account identifier of the group of one or more account identifiers, a related account profile based on a correspondence between the transaction time and/or date and transaction amount included in one or more of the merchant transaction entries included in the first data file that includes the respective account identifier and the transaction time and/or date and transaction amount included in one or more of the transaction data entries included in the respective account profile that includes a merchant identifier corresponding to the specific identifier;
identifying, by an analytic module of the processing server, one or more metric values for each identified account profile, wherein each of the one or more metric values is associated with the one or more desired metrics included in the received first data file and is based on at least one of: the transaction time and/or date, transaction amount, and additional transaction data included in each transaction data entry included in the respective account profile;
generating, by a generation module of the processing server, a second data file, wherein the second data file includes at least the account identifier corresponding to each of the identified account profiles; and
electronically transmitting, by a transmitting device of the processing server, the generated second data file.

2. The method of claim 1, wherein the second data file further includes the one or more metric values identified for each account identifier included in the second data file.

3. The method of claim 1, wherein
the first data file further includes a threshold value associated with each of the one or more desired metrics, and
the account identifiers included in the second data file are filtered to include only account identifiers where the corresponding identified one or more metric values exceed the threshold value associated with each of the respective associated desired metrics.

4. The method of claim 3, wherein the second data file further includes the one or more metric values for each account identifier included in the second data file subsequent to the filtering of the account identifiers.

5. The method of claim 1, wherein the one or more metric values identified for each account profile are further based on at least one of: the transaction time and/or date, transaction amount, and additional transaction data included in one or more transaction data entries included in one or more related account profiles.

6. The method of claim 5, wherein
the group of one or more account identifiers includes a single account identifier,
each account profile further includes one or more demographic characteristics, and
the one or more demographic characteristics included in each of the one or more related account profiles corresponds to the one or more demographic characteristics included in an account profile corresponding to the single account identifier.

7. A method for providing insight metrics for transaction behavior, comprising:
storing, in an account database of a processing server, a plurality of account profiles, wherein each account profile includes a structured data set related to a transaction account including at least a profile identifier and a plurality of transaction data entries, each transaction data entry including data related to a payment transaction involving the related transaction account including at least a transaction time and/or date, a transaction amount, a merchant identifier, and additional transaction data;
receiving, by a receiving device of the processing server, a first data file, wherein the first data file includes at least a specific identifier associated with a specific merchant and an account identifier of a group of one or more account identifiers;
executing, by a querying module of the processing server, a query on the account database to identify, for each account identifier of the group of one or more account identifiers, a related account profile based on a correspondence between the included profile identifier and the respective account identifier;
identifying, by an analytic module of the processing server, one or more metric values for each identified account profile, wherein each of the one or more metric values is associated with the one or more desired metrics included in the received first data file and is based on at least one of: the transaction time and/or date, transaction amount, and additional transaction data included in each transaction data entry included in the respective account profile;
generating, by a generation module of the processing server, a second data file, wherein the second data file includes at least the account identifier corresponding to each of the identified account profiles; and
electronically transmitting, by a transmitting device of the processing server, the generated second data file.

8. The method of claim 7, wherein the one or more metric values is further based on a correspondence between the transaction time and/or date, transaction amount, and additional transaction data included in each transaction data entry included in the respective account profile that includes a merchant identifier corresponding to the specific merchant identifier and the transaction time and/or date, transaction amount, and additional transaction data included in each transaction data entry included in the respective account profile that includes a merchant identifier that does not correspond to the specific merchant identifier.

9. The method of claim 7, wherein the second data file further includes the one or more metric values identified for each account identifier included in the second data file.

10. The method of claim 7, wherein
the first data file further includes a threshold value associated with each of the one or more desired metrics, and
the account identifiers included in the second data file are filtered to include only account identifiers where the corresponding identified one or more metric values exceed the threshold value associated with each of the respective associated desired metrics.

11. The method of claim 10, wherein the second data file further includes the one or more metric values for each account identifier included in the second data file subsequent to the filtering of the account identifiers.

12. The method of claim 7, wherein the one or more metric values identified for each account profile are further based on at least one of: the transaction time and/or date, transaction amount, and additional transaction data included in one or more transaction data entries included in one or more related account profiles.

13. The method of claim 12, wherein
the group of one or more account identifiers includes a single account identifier,
each account profile further includes one or more demographic characteristics, and
the one or more demographic characteristics included in each of the one or more related account profiles corresponds to the one or more demographic characteristics included in an account profile corresponding to the single account identifier.

14. A system for providing insight metrics for transaction behavior, comprising:
an account database of a processing server configured to store a plurality of account profiles, wherein each account profile includes a structured data set related to a transaction account including at least a plurality of transaction data entries, each transaction data entry including data related to a payment transaction involving the related transaction account including at least a transaction time and/or date, a transaction amount, a merchant identifier, and additional transaction data;
a receiving device of the processing server configured to receive a first data file, wherein the first data file includes at least a specific identifier associated with a specific merchant, one or more desired metrics, and a plurality of merchant transaction entries, each merchant transaction entry including data related to a payment transaction involving the specific merchant including at least a transaction time and/or date, a transaction amount, and an account identifier of a group of one or more account identifiers;
a querying module of the processing server configured to execute a query on the account database to identify, for each account identifier of the group of one or more account identifiers, a related account profile based on a correspondence between the transaction time and/or date and transaction amount included in one or more of the merchant transaction entries included in the first data file that includes the respective account identifier and the transaction time and/or date and transaction amount included in one or more of the transaction data entries included in the respective account profile that includes a merchant identifier corresponding to the specific identifier;
an analytic module of the processing server configured to identify one or more metric values for each identified account profile, wherein each of the one or more metric values is associated with the one or more desired metrics included in the received first data file and is based on at least one of: the transaction time and/or date, transaction amount, and additional transaction data included in each transaction data entry included in the respective account profile;
a generation module of the processing server configured to generate a second data file, wherein the second data file includes at least the account identifier corresponding to each of the identified account profiles; and
a transmitting device of the processing server configured to electronically transmit the generated second data file.

15. The system of claim 14, wherein the second data file further includes the one or more metric values identified for each account identifier included in the second data file.

16. The system of claim 14, wherein
the first data file further includes a threshold value associated with each of the one or more desired metrics, and
the account identifiers included in the second data file are filtered to include only account identifiers where the corresponding identified one or more metric values exceed the threshold value associated with each of the respective associated desired metrics.

17. The system of claim 16, wherein the second data file further includes the one or more metric values for each account identifier included in the second data file subsequent to the filtering of the account identifiers.

18. The system of claim 14, wherein the one or more metric values identified for each account profile are further based on at least one of: the transaction time and/or date, transaction amount, and additional transaction data included in one or more transaction data entries included in one or more related account profiles.

19. The system of claim 18, wherein
the group of one or more account identifiers includes a single account identifier,
each account profile further includes one or more demographic characteristics, and
the one or more demographic characteristics included in each of the one or more related account profiles corresponds to the one or more demographic characteristics included in an account profile corresponding to the single account identifier.

20. A system for providing insight metrics for transaction behavior, comprising:
an account database of a processing server configured to store a plurality of account profiles, wherein each account profile includes a structured data set related to a transaction account including at least a profile identifier and a plurality of transaction data entries, each transaction data entry including data related to a payment transaction involving the related transaction account including at least a transaction time and/or date, a transaction amount, a merchant identifier, and additional transaction data;
a receiving device of the processing server configured to receive a first data file, wherein the first data file includes at least a specific identifier associated with a specific merchant and an account identifier of a group of one or more account identifiers;
a querying module of the processing server configured to execute a query on the account database to identify, for each account identifier of the group of one or more account identifiers, a related account profile based on a correspondence between the included profile identifier and the respective account identifier;
an analytic module of the processing server configured to identify one or more metric values for each identified account profile, wherein each of the one or more metric values is associated with the one or more desired metrics included in the received first data file and is based on at least one of: the transaction time and/or date, transaction amount, and additional transaction data included in each transaction data entry included in the respective account profile;
a generation module of the processing server configured to generate a second data file, wherein the second data file includes at least the account identifier corresponding to each of the identified account profiles; and
a transmitting device of the processing server configured to electronically transmit the generated second data file.

21. The system of claim 20, wherein the one or more metric values is further based on a correspondence between the transaction time and/or date, transaction amount, and additional transaction data included in each transaction data entry included in the respective account profile that includes a merchant identifier corresponding to the specific merchant identifier and the transaction time and/or date, transaction amount, and additional transaction data included in each transaction data entry included in the respective account profile that includes a merchant identifier that does not correspond to the specific merchant identifier.

22. The system of claim 20, wherein the second data file further includes the one or more metric values identified for each account identifier included in the second data file.

23. The system of claim 20, wherein
the first data file further includes a threshold value associated with each of the one or more desired metrics, and
the account identifiers included in the second data file are filtered to include only account identifiers where the corresponding identified one or more metric values exceed the threshold value associated with each of the respective associated desired metrics.

24. The system of claim 23, wherein the second data file further includes the one or more metric values for each account identifier included in the second data file subsequent to the filtering of the account identifiers.

25. The system of claim 20, wherein the one or more metric values identified for each account profile are further based on at least one of: the transaction time and/or date, transaction amount, and additional transaction data included in one or more transaction data entries included in one or more related account profiles.

26. The system of claim 25, wherein
the group of one or more account identifiers includes a single account identifier,
each account profile further includes one or more demographic characteristics, and
the one or more demographic characteristics included in each of the one or more related account profiles corresponds to the one or more demographic characteristics included in an account profile corresponding to the single account identifier.
